(19) United States
(12) Patent Application Publication
(10) Pub. No.: US 2008/0130933 A1
(43) Pub. Date: Jun. 5, 2008

(54) Loudspeaker System

(75) Inventor: Toyofumi HAYASHI, Hamamatsu-shi (JP)

Correspondence Address: CROWELL & MORING LLP;INTELLECTUAL PROPERTY GROUP, P.O. BOX 14300, WASHINGTON, DC, 20044-4300, US

(73) Assignee: Yamaha Corporation, Hamamatsu-shi (JP)

(21) Appl. No.: 11/771,150

(22) Filed: Jun. 29, 2007

(30) Foreign Application Priority Data
Jun. 30, 2006 (JP) 2006-182304

(51) Int. Cl. H04R 1/00

(52) U.S. Cl. 381/354

(57) ABSTRACT

A loudspeaker system includes a loudspeaker, a sound wave guiding portion that has an opening portion, and guides a sound emitted from the loudspeaker to radiate the sound from the opening portion, and a thermal change portion that is provided on the sound wave guiding portion to form a temperature gradient in a space in the sound wave guiding portion.

### BACKGROUND OF THE INVENTION

The present invention relates to a structure for controlling a directivity of a loudspeaker.

As the loudspeaker system capable of enhancing a directivity, i.e., as the loudspeaker system having the so-called narrow directivity, there is the loudspeaker array, for example. In the loudspeaker array, the directivity is enhanced by controlling an amplitude and a phase in individual loudspeakers. A method of employing the loudspeaker array has a tendency to increase a size of the array because a plurality of loudspeakers are employed. In this case, as set forth in Patent Literature 1, for example, the directivity is enhanced in the loudspeaker of small size because a hood is fitted in front of the loudspeaker and the loudspeaker is arranged at a focal point of sound reflecting inner walls of the hood. Also, such a technology is disclosed that a position of the loudspeaker is changed by a lever to deviate the position from a focal position and spread intentionally the sound and thus the directivity of sound can be controlled.

[Patent Literature 1] JP-A-2006-101464

According to Patent Literature 1, the control of the directivity of sound is performed by moving physically a position of the loudspeaker. In this case, when the control of the directivity is performed frequently, a moving portion is moved too hard and is deteriorated. In such case, controllability of the moving portion becomes worse, e.g., the moving portion cannot return the loudspeaker to a proper focal position, or the like.

### SUMMARY OF THE INVENTION

The present invention has been made in view of the above circumstances, and it is an object of the present invention to provide a loudspeaker system of small size, capable of controlling a directivity of sound without moving portion.

In order to solve the above problems, the present invention provides a loudspeaker system, comprising:

a loudspeaker;

a sound wave guiding portion that has an opening portion, and guides a sound emitted from the loudspeaker to radiate the sound from the opening portion; and

a thermal change portion that is provided on the sound wave guiding portion to form a temperature gradient in a space in the sound wave guiding portion.

Preferably, The loudspeaker further includes a structural body that is arranged in the sound wave guiding portion or near the opening portion to pass the sound emitted from the loudspeaker. The structural body has different areas in thermal conductivity.

Preferably, the thermal change portion may be provided in plural. Also, at least one of the thermal change portions has a light emitting function or is formed of a Peltier element.

Preferably, the loudspeaker has an acoustic lens. The acoustic lens may have different areas in thermal conductivity.

Preferably, the sound wave guiding portion may have different areas in thermal conductivity. Also, the sound wave guiding portion is formed of materials that have different thermal conductivities respectively.

Preferably, the sound wave guiding portion has a light source.

Preferably, the sound wave guiding portion has a hole portion in a position which is different from a position of the opening portion.

Preferably, the loudspeaker system further include a control portion that controls a heating value of the thermal change portion.

According to the present invention, since a sound wave that tends to spread through the surrounding is caused to refract by a temperature gradient generated in the sound wave guiding portion, a directivity of sound can be controlled. Also, since the control of the directivity of sound is handled by the control of the thermal change portion, no moving portion is needed and thus the control can be made stable.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view of a loudspeaker system according to a first embodiment of the present invention;

FIG. 2 is a sectional view of the loudspeaker system according to the first embodiment of the present invention;

FIG. 3 is a conceptual view of a behavior of a sound wave in an inside of the loudspeaker system according to the first embodiment of the present invention;

FIG. 4 is a sectional view of a loudspeaker system according to a second embodiment of the present invention;

FIG. 5 is a perspective view of a cover of the loudspeaker system according to the second embodiment of the present invention;

FIG. 6 is a conceptual view of a behavior of a sound wave in an inside of the loudspeaker system according to the second embodiment of the present invention;

FIG. 7 is a sectional view of a loudspeaker system according to a third embodiment of the present invention;

FIG. 8 is a perspective view of a lower structural body of the loudspeaker system according to the third embodiment of the present invention;

FIG. 9 is a conceptual view of a behavior of a sound wave in an inside of the loudspeaker system according to the third embodiment of the present invention;

FIG. 10 is a sectional view of a loudspeaker system according to a variation 1 of the present invention;

FIG. 11 is a sectional view of a loudspeaker system according to a variation 2 of the present invention;

FIG. 12 is a perspective view of an acoustic lens used in a loudspeaker system according to a variation 4 of the present invention;

FIG. 13 is a sectional view of a loudspeaker system according to a variation 5 and a variation 7 of the present invention;

FIG. 14 is a sectional view of a loudspeaker system according to a variation 8 of the present invention; and

FIG. 15 is a connection conceptual view of a controlling portion for controlling a heat source according to a variation 9 of the present invention.

### DETAILED DESCRIPTION OF THE PREFERRED EMBODIMENTS

Embodiments of the present invention will be explained hereinafter.

### First Embodiment

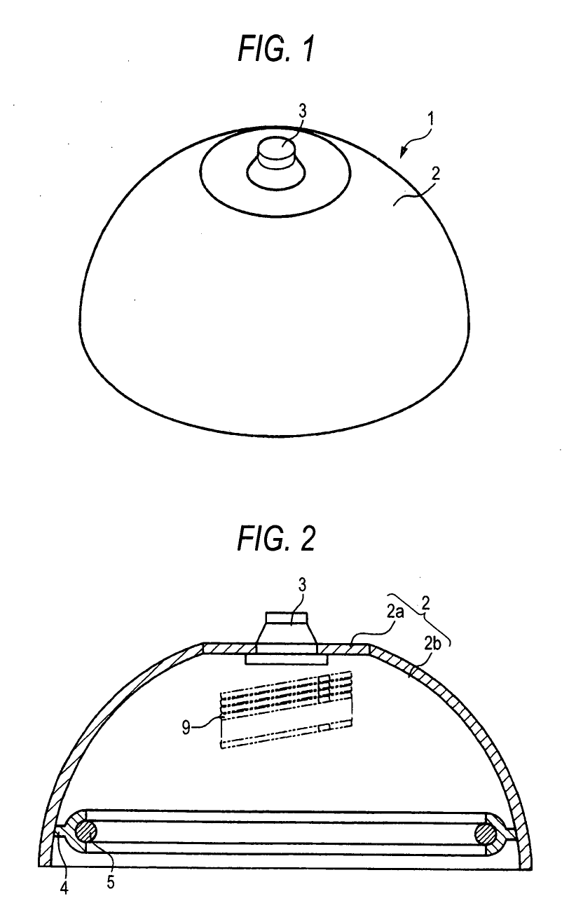

FIG. 1 is a perspective view showing an external appearance of a loudspeaker system 1 as a first embodiment of the present invention. The loudspeaker system 1 has an outer wall 2 shaped into a hollow hemisphere whose bottom side is opened and whose top portion is cut off by a plane that is parallel with an open surface on the bottom side, and a loudspeaker 3.

FIG. 2 is a sectional view of the loudspeaker system 1, and shows a section being taken by a plane that passes through a center of a bottom surface of the outer wall 2 and is perpendicular to the bottom surface. As shown in FIG. 2, the outer wall 2 has a side wall 2b as a side surface of a spherical body and a top plate 2a on the upper side. A loudspeaker fitting hole is opened in the top plate 2a, and the loudspeaker 3 is fitted to direct its diaphragm (a cone paper, or the like) downward.

An annular heat source 5 formed like a concentric circle is fitted to a hemispherical space (sound wave guiding path), which is covered with the outer wall 2, near the lower end of the opening portion of the outer wall 2 along a semicircular direction of the opening portion of the outer wall 2. The heat source 5 is supported on the side wall 2b by a supporting body 4.

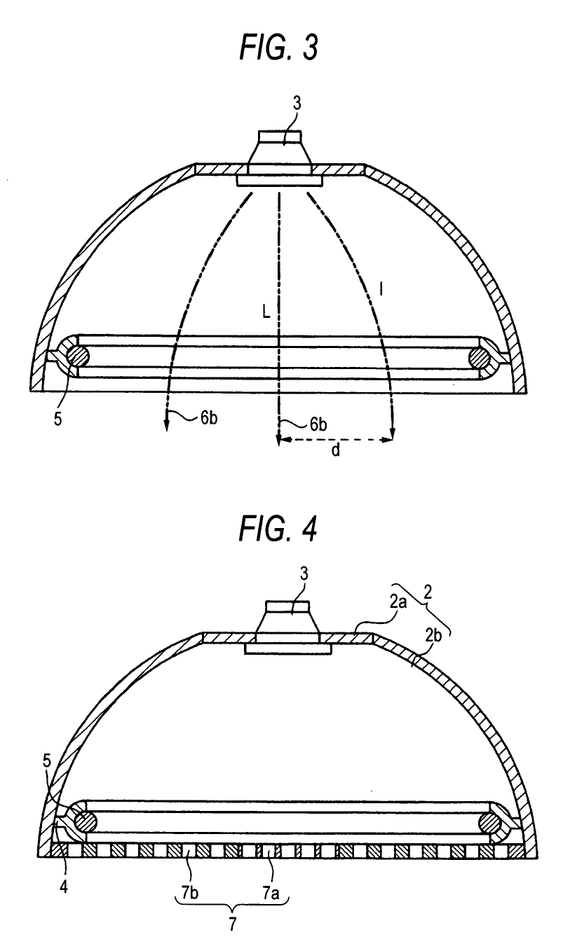

FIG. 3 is a view showing the emitted direction of the sound wave when the loudspeaker 3 is driven in a state that the heat source 5 is generating heat, in the above configuration. When the heat source 5 generates the heat, a temperature around the heat source 5 is increased, so that a temperature gradient is generated between a neighborhood of a line extending vertically from a center of the opening portion (referred to as a “center axis” hereinafter) of the outer wall 2 and a neighborhood of the heat source 5. The sound wave emitted from the loudspeaker 3 propagates through a semispherical space that the outer wall 2 covers. In this case, a wave front of the sound wave, which passes near the center axis, goes straight on because no deviation lies in a surrounding temperature distribution. In contrast, a wave front of the sound wave, which passes near the heat source 5 positioned away from the center axis, goes faster than the wave front that passes near the center axis. In this manner, the sound wave is refracted to the center axis direction, at which a temperature is low, because of a deviation of the temperature distribution that is caused in the semispherical space that the outer wall 2 covers. As a result, the sound wave travels to gather around the center axis rather than a state that the heat source 5 does not generate the heat, and thus the sound is emitted from the opening portion of the outer wall 2 to the outside in a state that the directivity of sound is enhanced. That is, as shown in FIG. 3, a sound wave 6a passing near the center axis goes substantially straight on, while a sound wave 6b passing near the inner wall surface of the outer wall 2 is refracted to the center axis direction. In case of usual pendant size, this kind of “Acoustic lens effect” is achieved when thermal difference between the inner axis and the outer wall is some ten degrees centigrade.

Here, when a heating value is increased or decreased, a temperature gradient is changed. Therefore, an amount of refraction of the sound wave 6b that passes near the inner wall surface of the outer wall 2 is increased or decreased, a way of spreading of the sound is changed. As a result, the directivity of sound can be controlled by controlling a heating value of the heat source 5.

The acoustic lens effect caused by the temperature gradient will be explained by using FIG. 3. In a case that the sound wave emitted from the loudspeaker 3 (which is regarded as a point sound source) is emitted to a lower portion of the outer wall 2 as a plane wave, not a spherical wave, the acoustic lens effect is achieved. In other words, the expression “the sound wave is emitted to the lower portion as the plane wave” means that wave fronts of the sound wave emitted from the lower portion are arranged in the same plane. To arrange the wave fronts of the sound wave on the same plane at the lower portion of the outer wall 2 (the hemispherical wall), it is required that the sound wave emitted from the loudspeaker 3 and passed through a path h arranged on the center axis and the sound wave emitted from the loudspeaker 3 and passed through a path l are reached to the opening portion of the outer wall 2 simultaneously. That is, it is required that the sound wave passed through the path l which is longer than the path h is faster than the sound wave passed through the path h. Following explanation shows a condition as preferable values to achieve the acoustic lens effect caused by the temperature gradient.

The science chronology shows a temperature coefficient of an air sound velocity as 0.6 m/sec/° C. Therefore, if the thermal difference between the path h and the path l is t, the condition in which the wave fronts of the sound wave passed through the path l and the sound wave passed through the path h are simultaneously reached to the opening portion is expressed as h/c=l/(c+0.6 t).

If the path l is approximated as a straight line, the path l is expressed as l˜\sqrt{(h²+d²)}. In a case of the pendant type speaker system (a pendant type illumination), the length of the path h is 0.4 m and the distance d between the path h and the path l at the opening portion is 0.15 m. The sound velocity at the path h is 340 m/sec.

If the above values are assigned to the above expression, the expression shows as follows.

0.4/340=0.4271/(340+0.6t)

t=38.5° C.

In view of the above, if such thermal distance is made to the speaker system, the desirable acoustic lens effect can be achieved.

### Second Embodiment

FIG. 4 is a sectional view of a loudspeaker system according to a second embodiment of the present invention. In the second embodiment, a cover 7 (structural body) for covering the opening portion is added to the structure in the first embodiment.

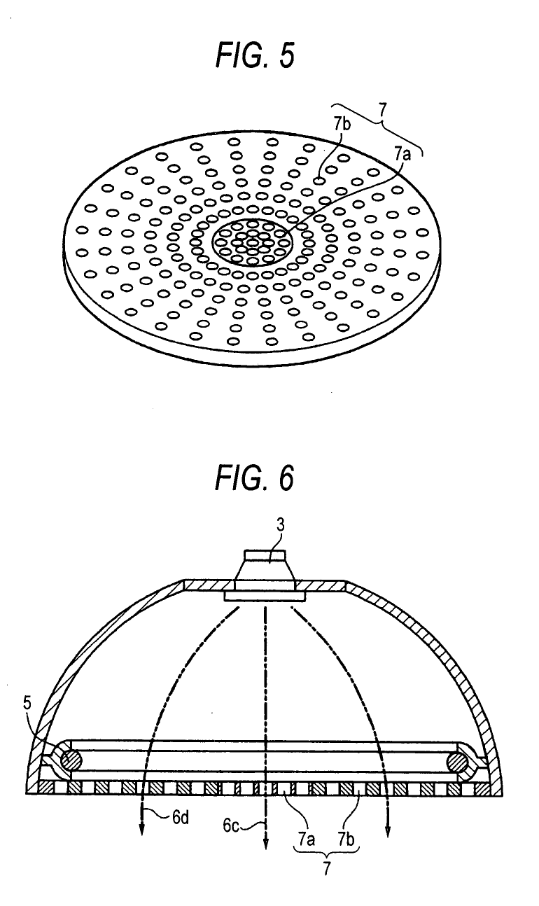

FIG. 5 is a perspective view showing an external appearance of the cover 7. As shown in FIG. 6, a peripheral portion of the cover 7 is joined to a peripheral portion of the lower end of the side wall 2b. The cover 7 has a circular cover center portion 7a, and a cover outer peripheral portion 7b for surrounding the cover center portion 7a like a concentric circle. Also, the cover outer peripheral portion 7b is formed of the material whose thermal conductivity is higher then the cover center portion 7a. Also, a large number of holes passing through the cover 7 vertically are provided in both the cover center portion 7a and the cover outer peripheral portion 7b such that the sound emitted from the loudspeaker 3 is caused to propagate to the outside via these holes.

FIG. 6 is a view showing the emitted direction of the sound wave when the loudspeaker 3 is driven in a state that the heat source 5 is generating heat, in the above configuration. When the heat source 5 generates the heat, a temperature around the heat source 5 is increased, so that a temperature gradient is generated between a neighborhood of a center axis of the outer wall 2 and a neighborhood of the heat source 5. Also, since a thermal conductivity of the cover outer peripheral portion 7b is higher than the cover center portion 7a, a heat of the heat source 6 transfers effectively. Thus, an area in which a temperature rises is widened in contrast to the first embodiment. In contrast, since the cover center portion 7a has a thermal conductivity lower than the cover outer peripheral portion 7b, a heat of the heat source 5 is hard to transfer near the center axis. Therefore, a temperature gradient is sharpened near a boundary between the cover center portion 7a and the cover outer peripheral portion 7b. The sound wave emitted from the loudspeaker 3 propagates through a semispherical space that the outer wall 2 covers. In this case, a wave front of the sound wave, which passes near the center axis, goes straight on because no deviation lies in a surrounding temperature distribution. In contrast, a wave front of the sound wave, which passes near the heat source 5 positioned away from the center axis and near the cover outer peripheral portion 7b, goes faster than the wave front that passes near the center axis. In this manner, the sound wave is refracted to the center axis direction, at which a temperature is low, because of a deviation of the temperature distribution that is caused in the semispherical space that the outer wall 2 covers. As a result, the sound wave travels to gather around the center axis rather than a state that the heat source 5 do not generate the heat, and thus the sound is emitted from the lower surface of the cover 7 to the outside in a state that the directivity of sound is enhanced. That is, as shown in FIG. 6, a sound wave 6c passing near the center axis goes almost straight on, while a sound wave 6d passing near the inner wall surface of the outer wall 2 and near the cover outer peripheral portion 7b is refracted to the center axis direction.

Here, when a heating value is increased or decreased, a temperature gradient is changed. Therefore, an amount of refraction of the sound wave 6d that passes near the inner wall surface of the outer wall 2 and near the cover outer peripheral portion 7b is increased or decreased, a way of spreading of the sound is changed. As a result, the directivity of sound can be controlled by controlling a heating value of the heat source 5.

### Third Embodiment

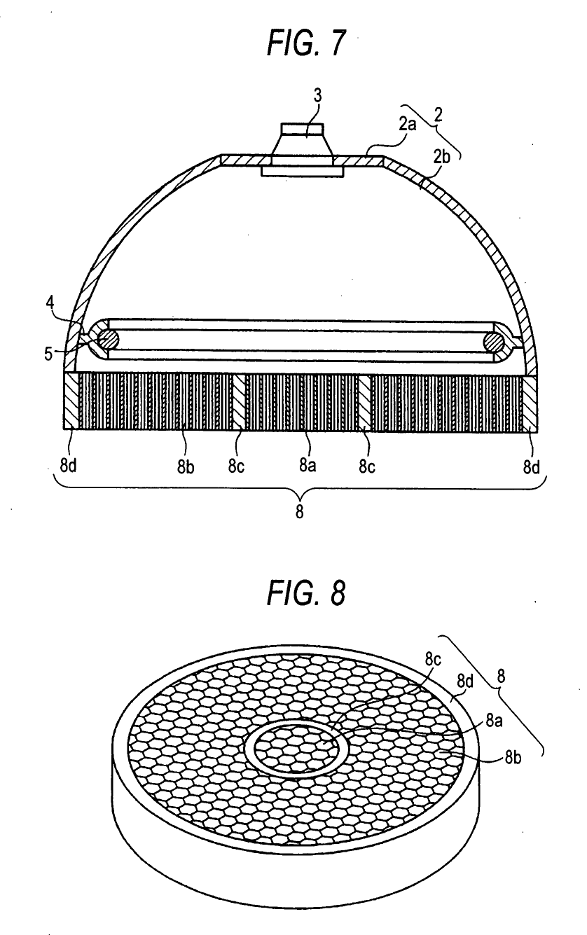

FIG. 7 is a sectional view showing a section of a loudspeaker system as a third embodiment of the present invention. In the third embodiment, a cylindrical lower structural body 8 (structural body) is added to the structure in the first embodiment.

FIG. 8 is a perspective view showing an external appearance of the lower structural body 8. As shown in FIG. 8, a peripheral portion of a top end of the lower structural body 8 is joined to a peripheral portion of a bottom end of the side wall 2b. The lower structural body 8 has an internal structural body 8a, an outer structural body 8b, a Peltier element 8c, and an outer frame 8d. The internal structural body 8a has a circular cylindrical shape, and the Peltier element 8c is formed to cover a circular cylindrical side surface of the internal structural body 8a. Also, the outer structural body 8b is formed to cover an outer peripheral side surface of the Peltier element 8c. Also, the outer structural body 8b is covered with the outer frame 8d. The internal structural body 8a and the outer structural body 8b have a honeycomb structure through which through holes are formed respectively such that the sound emitted from the loudspeaker 3 propagates to the outside through a mass of cells in the honeycomb structure.

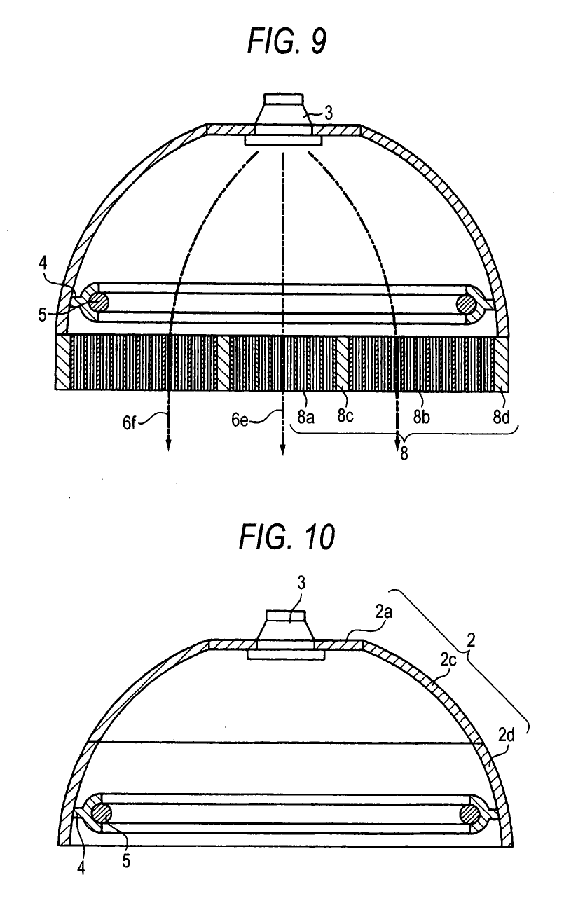

FIG. 9 is a view showing the emitted direction of the sound wave when the loudspeaker 3 is driven in a state that the heat source 5 is generating heat and the Peltier element 8c is operated, in the above configuration. Here, the Peltier element 8c is operated to absorb the heat from its inner surface side facing to the internal structural body 8a and radiate the heat to its outer surface side facing to the outer structural body 8b. The Internal structural body 8a is cooled by the Peltier element 8c, and the outer structural body 8b is heated by the heat source 5 and the Peltier element 8c. A temperature gradient is generated between a neighborhood of the heat source 5 and a neighborhood of the outer structural body 8b and a neighborhood of the Internal structural body 8a. Also, a temperature gradient is sharpened around the Peltier element 8c. The sound wave emitted from the loudspeaker 3 propagates through a semispherical space that the outer wall 2 covers. In this case, a wave front of the sound wave, which passes near the internal structural body 8a, goes straight on because no deviation lies in a surrounding temperature distribution. In contrast, a wave front of the sound wave, which passes near the heat source 5 and near the outer structural body 8b, goes faster than the wave front that passes near the Internal structural body 8a. In this manner, the sound wave is refracted to the center axis direction, at which a temperature is low, because of a deviation of the temperature distribution that is caused in the semispherical space that the outer wall 2 covers. As a result, the sound wave travels to gather around the center axis rather than a state that the heat source 5 do not generate the heat and the Peltier element 8c is not operated, and thus the sound is emitted from the lower end of the lower structural body 8 to the outside in a state that the directivity of sound is increased. That is, as shown in FIG. 6, a sound wave 6e passing near the internal structural body 8a goes almost straight on, while a sound wave 6f passing near the inner wall surface of the outer wall 2 and near the outer structural body 8b is refracted to the center axis direction.

Here, when a heating value is increased or decreased, a temperature gradient is changed. Therefore, an amount of refraction of the sound wave 6f that passes near the Inner wall surface of the outer wall 2 and near the outer structural body 8b is increased or decreased, a way of spreading of the sound is changed. As a result, the directivity of sound can be controlled by controlling a heating value of the heat source 5 and a heat absorption amount and a heat radiation amount of the Peltier element 8c.

### <Variation 1>

The embodiments of the present invention are explained as above. But the present invention may be carried out by varying the above embodiments as follows, for example.

In the first embodiment, the overall side wall 2b is formed of the same material. In a variation 1 shown in FIG. 10, the side wall consists of an upper side wall 2c and a lower side wall 2d, and the lower side wall 2d is formed of the material whose thermal conductivity is higher than the upper side wall 2c. When constructed in this manner, an area in which a temperature is high is widened since the heat generated from the heat source 5 transfers effectively to the lower side wall 2d. Therefore, an amount of refraction of the sound wave 6b passing near the inner wall surface of the outer wall 2 can be increased, and thus a range in which the directivity of the sound can be controlled can be expanded.

### <Variation 2>

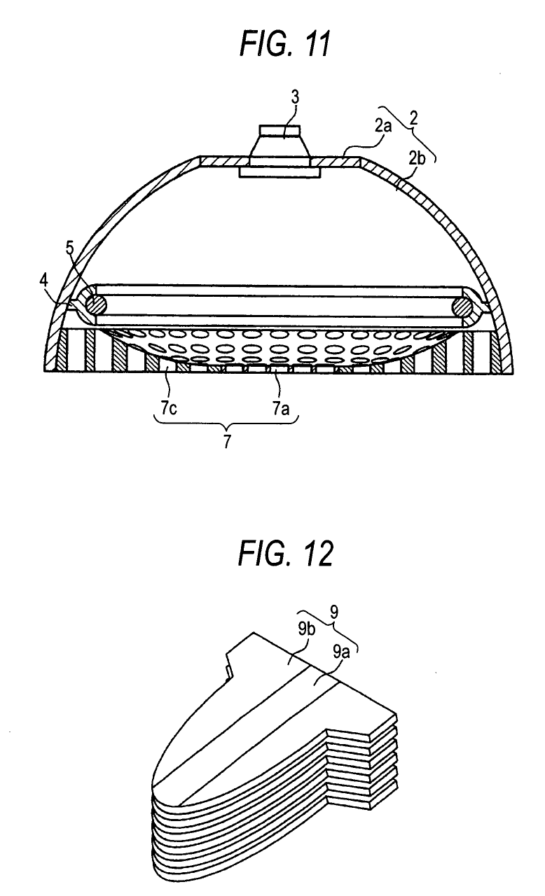

In the second embodiment, the cover 7 is formed to have a uniform thickness. As shown in FIG. 11, a cover outer peripheral portion 7c may be formed such that a thickness is increased gradually toward its outer periphery. Accordingly, a gradient can be given to a magnitude of the thermal conductivity by increasing the thermal conductivity gradually toward the outer periphery. Also, a gradient may be given to a magnitude of the thermal conductivity by varying a shape of the cover 7, a density of the material, a size of the hole, or the like.

In this manner, when a predetermined gradient in a magnitude of the thermal conductivity is given to the cover 7 itself that covers the opening portion, a temperature gradient in vicinity of the cover 7 becomes almost equal to a temperature gradient of the cover 7. Therefore, a temperature gradient of the overall semispherical space that the outer wall 2 covers can be stabilized. As a result, the directivity of the sound can be designed with high accuracy. In this case, the cover 7 has a structure in which a large number of holes are provided. But this cover 7 may have a honeycomb structure or a structure that is constructed by a mass of pipes.

### <Variation 3>

In the third embodiment, the internal structural body 8a and the outer structural body 8b have a honeycomb structure respectively, but these structural bodies may be constructed by a mass of pipes. Also, like the variation 2, a gradient may be given to a magnitude of the thermal conductivity by varying a thickness of the internal structural body 8a or the outer structural body 8b, changing a size, a shape, a density of the holes, and the like. As a result, like the above, a temperature gradient of the semispherical space that the outer wall 2 covers can be stabilized, and thus the directivity of the sound can be designed with high accuracy.

### <Variation 4>

In the first embodiment, as indicated by a broken line in FIG. 2, the directivity of the sound emitted from the loudspeaker 3 may be increased by arranging an acoustic lens 9. In addition, as shown in FIG. 12, the acoustic lens 9 may have an acoustic lens center portion 9a and an acoustic lens peripheral portion 9b, and a thermal conductivity of the acoustic lens peripheral portion 9b may be set higher than that of the acoustic lens center portion 9a. Accordingly, the acoustic lens 9 is subjected to the surrounding heat and the acoustic lens peripheral portion 9b is heated effectively. Therefore, the surrounding temperature is increased and thus an effect of the acoustic lens can be enhanced. As a result, a range in which the directivity of sound can be controlled can be expanded.

### <Variation 5>

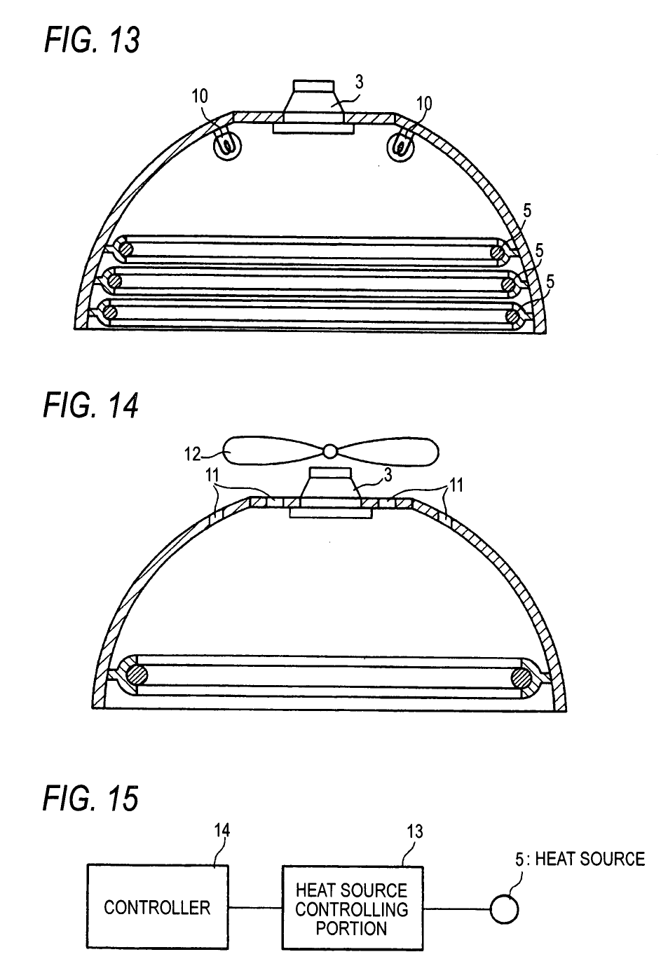

In the first embodiment, as shown in FIG. 13, the supporting body 4 and the heat source 5 may be provided in plural. Hence, an area in which a temperature is high can be widened. As a result, an amount of refraction of the sound wave 6b passing near the inner wall of the outer wall 2 can be increased, and thus a range in which the directivity of sound can be controlled can be expanded.

### <Variation 6>

In the first embodiment, the heat source 5 may be replaced with a cooling source. When done in this manner, the direction in which the sound wave 6b passing near the inner wall surface of the outer wall 2 is refracted can be widened outward. In other words, an effect of enhancing a diffusibility of the sound can be employed in place of an effect of sharpening the directivity. Also, when the element such as the Peltier element, or the like, the heat source and the cooling source of which can be switched, is employed, the acoustic output characteristic can be controlled widely from the sharp directivity to the wide diffusibility.

### <Variation 7>

In the first embodiment, as shown in FIG. 13, when light sources 10 are provided to an inside of the semispherical space that the outer wall 2 covers or a light emitting function is provided to the heat source 5, the loudspeaker system can also be used as a luminaire.

### <Variation 8>

A convection of air is caused in the hemispherical space that the outer wall 2 covers due to a temperature difference in the inside. Thus, sometimes the temperature becomes unstable depending on a temperature of the heat source 5, a size of the space, the surrounding temperature, or the like. In such case, for example, as shown in FIG. 14, an inner space may be ventilated by opening air holes 11 in the outer wall 2. Hence, a fluctuation of the directivity of sound can be prevented by stabilizing a temperature distribution. Also, a ventilation fan 12 may be provided near the air holes 11 to increase a ventilation efficiency.

### <Variation 9>

In the first embodiment, as shown in FIG. 15, a system for controlling the heat source 5 may be employed to change a heating value of the heat source 5. This system includes a heat source controlling portion 13, and a controller 14 for controlling the heat source controlling portion 13. Accordingly, control of the directivity of sound can be performed simply by operating a volume provided to the controller 14, or the like. Also, when the Peltier element is employed, any control such as focusing or diffusing the sound, or the like can be handled by causing the controller 14 to switch its heating operation and its cooling operation.

### [NEW]

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2006-182304 filed on Jun. 30, 2006, the contents of which are incorporated herein for reference.

What is claimed is:

1. A loudspeaker system, comprising:
a loudspeaker;
a sound wave guiding portion that has an opening portion, and guides a sound emitted from the loudspeaker to radiate the sound from the opening portion; and
a thermal change portion that is provided on the sound wave guiding portion to form a temperature gradient in a space in the sound wave guiding portion.

2. The loudspeaker system according to claim 1, further comprising:
a structural body that is arranged in the sound wave guiding portion or near the opening portion to pass the sound emitted from the loudspeaker,
wherein the structural body has different areas in thermal conductivity.

3. The loudspeaker system according to claim 1, wherein a plurality of the thermal change portions are provided.

4. The loudspeaker system according to claim 1, wherein the loudspeaker has an acoustic lens.

5. The loudspeaker system according to claim 4, wherein the acoustic lens has different areas in thermal conductivity.

6. The loudspeaker system according to claim 3, wherein at least one of the thermal change portions is a Peltier element.

7. The loudspeaker system according to claim 1, wherein the sound wave guiding portion has different areas in thermal conductivity.

8. The loudspeaker system according to claim 3, wherein at least one of the thermal change portions has a light emitting function.

9. The loudspeaker system according to claim 1, wherein the sound wave guiding portion has a light source.

10. The loudspeaker system according to claim 1, wherein the sound wave guiding portion has a hole portion in a position which is different from a position of the opening portion.

11. The loudspeaker system according to claim 1, further comprising:
a control portion that controls a heating value of the thermal change portion.
